(19) United States
(12) Patent Application Publication
(10) Pub. No.: US 2008/0014559 A1
(43) Pub. Date: Jan. 17, 2008

(54) Method and Apparatus for Attaching Dental Restorations

(76) Inventor: Philip Love, Calgary (CA)

Correspondence Address: Bay Area Patent Group, LLC, 13630 58TH ST. NORTH, SUITE 101, CLEARWATER, FL, 33760, US

(21) Appl. No.: 11/457,173

(22) Filed: Jul. 13, 2006

(51) Int. Cl. A61C 5/04; A61C 1/00

(52) U.S. Cl. 433/226; 433/29

(57) ABSTRACT

A method and apparatus for attaching a dental restoration to a tooth through spot curing a bonding agent to allow excess bonding agent displaced beyond the margin of the restoration to be wiped cleaning from the surrounding surfaces without displacing the restoration. The method includes applying a dental bonding agent to an exterior bonding surface of a dental restoration that will facilitate the adhesion of the dental restoration to a dental surface. Positioning the dental restoration on the dental surface. Spot hardening the dental bonding agent to partially adhere the dental restoration to the dental surface. Removing excess dental bonding agent, and hardening the remaining dental bonding agent to fully adhere the dental restoration to the dental surface. The apparatus for performing the method includes an optical fiber, and a dental adhesive connecting a proximal end of the optical fiber to the outward facing surface of the dental restoration with the optical fiber extending generally perpendicular from the outward facing surface and terminating at a distal end.

### FIELD OF THE INVENTION

The present invention relates generally to dental equipment and techniques. More particularly, relating to a method and apparatus for facilitating the positioning of tooth veneers or other dental restorations on a patient's teeth that reduces time required for the procedure and increases accuracy of tooth veneer or restoration placement.

### BACKGROUND OF THE INVENTION

For a variety of reasons, the enamel surfaces of teeth sometimes become permanently stained, decayed or damaged. A technique has been developed to repair or improve the appearance and function of such teeth.

In a procedure referred to as cosmetic bonding, a thin veneer of ceramic or plastic having a shape and curvature matching the outline, shape and surface curvature of a tooth to be refaced is bonded to the facial or labial surface of the tooth, after the tooth has been specially prepared. The veneer has a desired surface coloration and gloss to match adjacent teeth. The veneer is sufficiently opaque to mask a stained surface of the underlying tooth. By this procedure, teeth may be restored to a more pleasing and functional appearance.

The number of individually demanding steps required to fabricate each tooth veneer results in a substantial investment in time. Thus, the replacement value of each custom-made veneer is significant. Accordingly, considerable care must be exercised in handling a veneer to avoid damage to it. The veneer is relatively fragile until it has been bonded or laminated to and supported by the tooth for which it was custom-fabricated.

After a number of preparation steps, the veneer is temporarily placed on the appropriate tooth. The purpose of the temporary placement is to check size, opacity and coloration of the veneer. After this preliminary testing, the veneer is removed, and both the veneer and tooth thoroughly cleaned of the temporary adhesive and dried. The veneer or other restoration is then permanently bonded to the supporting tooth. Typically this is done with a light sensitive bonding agent. The inner surface of the restoration is coated with such bonding agent, and the restoration placed in position on the tooth. All of these procedures are usually performed by the dentist holding the substantially small, fragile restoration between his or her thumb and forefinger. Needless to say, many of these small restorations are inadvertently dropped or damaged during the fitting, adjustment and placement phase.

Another difficulty encountered in positioning and permanently bonding a restoration to a tooth concerns the permanent bonding agent employed. One type that is frequently utilized is a composite resin that is fairly viscous or stiff. The material should, of course, be spread between all of the mating surfaces of the restoration and the base tooth. It is also desirable that any excess bonding agent be squeezed out from between the restoration and the tooth.

It is very desirable to remove this excess bonding agent from the surface of the restoration and surrounding dental surfaces, including adjacent teeth, and gums before the bonding agent is cured to prevent the requirement of scraping these surfaces free of the bonding agent after curing. Currently, this procedure includes the careful placement of the restoration or veneer on the prepared tooth surface, and while holding the restoration in place using a finger or placement tool, wiping the surrounding dental surfaces free of the bonding agent. Wiping of the surrounding surfaces typically results in movement of the restoration or veneer, requiring the dentist to reposition the restoration or veneer. This process typically has to be repeated several times before the restoration or veneer is positioned correctly without excess bonding agent present on the surrounding dental surface. As a result, the overall time for completing the procedure of cosmetic bonding is increased per each bonding.

Accordingly, a need exists for an improved, simplified tool and technique for handling and bonding veneers and other restorations.

### SUMMARY OF THE INVENTION

The present invention provides a new apparatus and method wherein the same can be used for placing and bonding dental restorations to dental surfaces. Dental restorations such as veneers, inlays and crowns are very small and fragile, and are difficult to handle and place accurately without damaging or dropping them. The present invention provides a bonding technique and apparatus to immobilize the restoration against a tooth surface and a handle to hold the restoration throughout the entire bonding process.

As described above, once a restoration is correctly positioned, excess bonding agent around the margin of the restoration must be cleaned from the surrounding surfaces. Removing the excess bonding agent is difficult because the bonding agent must remain as a liquid for it to be removed, which leaves the restoration vulnerable to accidental displacement. The technique of the apparatus and method of the present invention aids in the final placement of a dental restoration on a tooth and the cleaning of excess bonding agent from the margin of the restoration. The technique involves curing only a portion of the bonding agent about a central portion of the restoration, thereby partially bonding the restoration to the tooth. With the restoration partially bonded, the restoration margin can be cleaned from excess bonding agent without displacing the restoration from its final position. The result is a more accurately positioned restoration while decreasing the required time for a patient to be in a dental chair making the bonding procedure more desirable.

In general, in one aspect, method of attaching a dental restoration to a dental surface is provided. The method includes the steps of applying a dental bonding agent to an exterior bonding surface of a dental restoration that will facilitate the adhesion of the dental restoration to a dental surface. Positioning the dental restoration on the dental surface. Spot hardening the dental bonding agent to partially adhere the dental restoration to the dental surface. Removing excess dental bonding agent, and hardening the remaining dental bonding agent to fully adhere the dental restoration to the dental surface.

In general, in one aspect, method of attaching a dental restoration to a dental surface is provided. The method includes the steps of attaching a light transmissive member to an outward facing surface of the dental restoration. Applying a light curable dental bonding agent to a bonding surface of the dental restoration that will facilitate the adhesion of the dental restoration to a dental surface. Positioning the dental restoration on the dental surface. Transmitting a source of curing light through the light transmissive member to spot cure the dental bonding agent to partially adhere the dental restoration to the dental surface. Removing excess bonding agent, and curing the remaining dental bonding agent to fully adhere the dental restoration to the dental surface.

In general, in another aspect, dental combination for attaching a dental restoration is provided. The dental combination includes a dental restoration having a surface to be bonded to a tooth and an outward facing surface which becomes a surface of the tooth. An optical fiber, and a dental adhesive connecting a proximal end of the optical fiber to the outward facing surface of the dental restoration with the optical fiber extending generally perpendicular from the outward facing surface and terminating at a distal end.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an diagrammatic perspective view illustrating an explode dental combination provided in accordance with the principles of the present invention;

FIG. 2 is a front plan view of the illustrating several dental restorations having the bonding agent spot cured partially adhered the dental restorations to each respective dental surfaces;

FIG. 3 is a sectional view illustrating the spot curing of the dental bonding agent; and

FIG. 4 is a sectional view illustrating the curing of the remaining dental bonding agent.

### DETAILED DESCRIPTION OF THE INVENTION

Generally, a method of the invention provides for partial adhesion of a dental restoration, such as a veneer, to a dental surface, such as a tooth by spot hardening or curing of a dental bonding agent allowing excess bonding agent to be wiped away without displacing the veneer from is final position on the tooth. Once, the excess bonding agent is removed, the remaining bond agent is hardened or cured to fully adhere the veneer to the tooth.

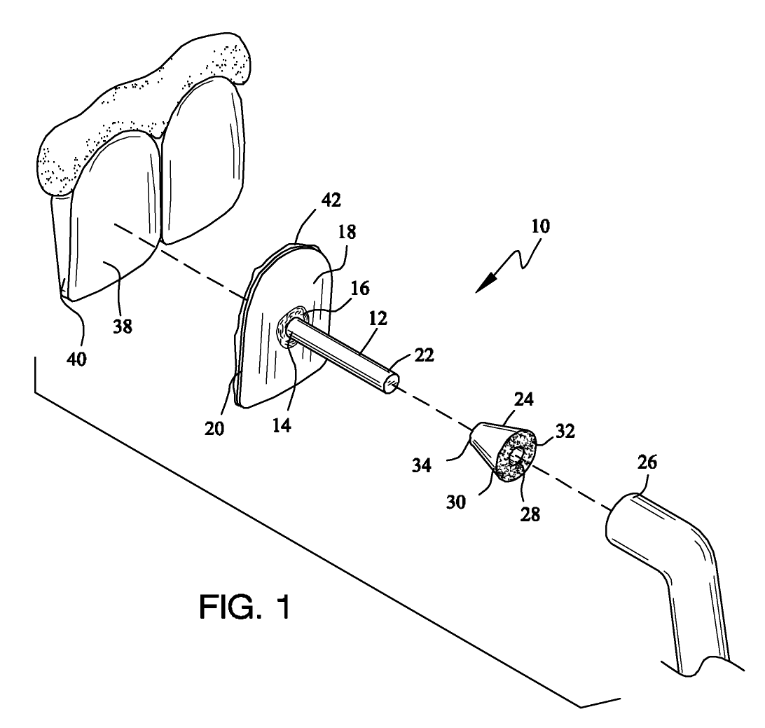

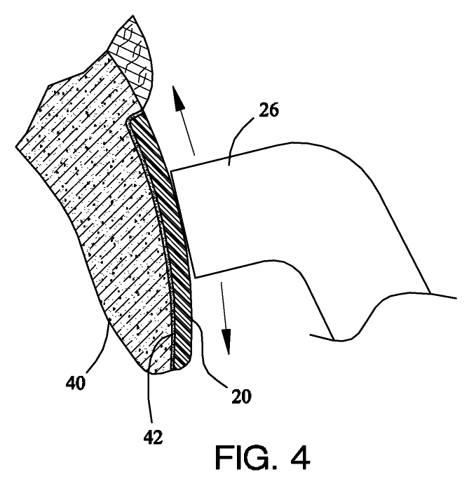

With reference now to FIGS. 1-4 of the drawings, reference numeral 10 generally designates a dental combination of the present invention utilized in the methods of the present invention of placing and bonding dental restorations, such but not limited to veneers, inlays and crowns to a tooth.

FIG. 1, illustrates a light transmissive member 12 attached at a proximal end 14 by an adhesive 16 at a central location of an outward facing surface 18 of a dental restoration 20 in the form of a veneer. The light transmissive member 12 extends generally perpendicular from the outward facing surface 18 and terminates at distal end 22. The light transmissive member 12 is useful in positioning a veneer as shown, but can of course be used for crowns, inlays or other dental restorations, either in a mouth or on a laboratory model.

It is desirable the light transmissive member 12 be a fiber optic of a length of about 25 to about 35 millimeters, and a diameter of about 2.5 to about 3.5 millimeters. The upper and lower limits of these dimensions provide the light transmissive member 12 as a suitable gripping element to aid in the handling the dental restoration throughout the entire bonding process including try-in, etching, bonding agent application, and final placement. The proximal and distal ends 14, 22 of the light transmissive member 12 are highly polished. The light transmissive member 12 can be sheathed to prevent interfering with the optical properties thereof. The light transmissive member 12 may be straight or curved to allow better access to the margins of the restoration 20 and to decrease likelihood of interference with the patient's lip or opposing occlusion.

The adhesive 16 is similar to that of orthodontic wax, a commonly available dental product, and has an adhesion which resists the force of air and water spray on the dental restoration 20 yet leaves no residue on the dental restoration when removed. It is also desirable that the adhesive 16 be translucent.

An adaptor 24 is provided for attachment to the light transmitting end 26 of a typical light curing unit intermediate the distal end 22 of the light transmissive member 12 to facilitate directing light from the light curing unit through the light transmissive member. The adaptor 24 includes a longitudinal through passage 28 through which light transmitted from the light curing unit is free to pass. It is desirable the adaptor 24 is formed of an opaque material and is conically shaped. The wide end 30 being sized to for attachment to the light curing unit aligning the light transmitting end 26 with the through passage 28. A pressure sensitive adhesive 32 can be applied to the wide end 30 to facilitate the removable attachment of the adaptor 24 to the light curing unit. The narrow end 34 is adapted to removably receive the distal end 22 of the light transmissive member 12.

In utilizing the dental combination 10 in the methods of the present invention, the light transmissive member 12 is attached at the proximal end 14 by the adhesive 16 at a central location of the outward facing surface 18 of the dental restoration 20. After the light transmissive member 12 is attached to dental restoration 20, the restoration can be positioned on the tooth or tooth model as many times a desired or as is necessary in the various adjusting, color-matching and bonding steps as needed. The dental restoration 20 can also be held by the light transmissive member 12 while the restoration is being adjusted with dental tools by either a technician or the dentist.

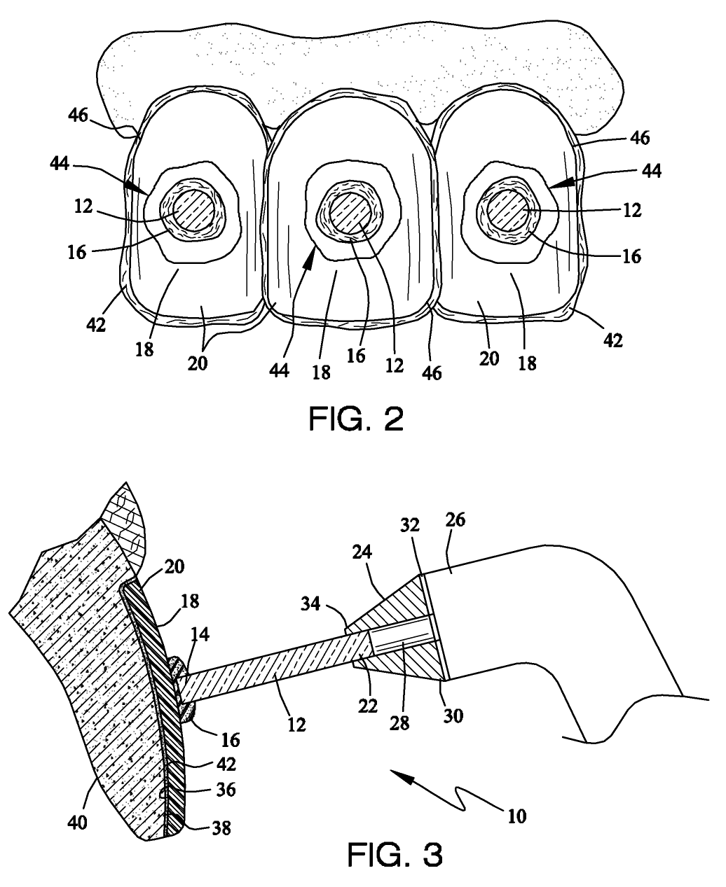

Once the dental restoration is ready to be bonded, a bonding agent 42 is applied to a bond surface 36 of the dental restoration 20. Then using the light transmissive member 12 as a handle, the dental restoration 20 is positioned on a prepared tooth surface 38 of a tooth 40 to be bonded, as best shown in FIGS. 2 and 3. Once the restoration 20 is correctly positioned, the bonding agent 42 is evenly distributed between the restoration and the tooth 40 squeezing excess bonding agent 42 from between the bonding surface 36 and the tooth surface 38, as best seen in FIG. 2. Curing light from the light curing unit is transmitted through the light transmissive member 12 to spot cure, generally designated at 44, the bonding agent 42 about the central portion of the bonding surface 36 of the dental restoration 20 to partially bond the restoration to the tooth 40. Spot curing the bonding agent 42 only about the central portion of the dental restoration 20 leaves the bonding agent beyond the central portion as a liquid but securely attaches the restoration to the tooth 40.

With the dental restoration 20 partially bonded to the tooth 40, the excess bonding agent 42 that extends beyond the margin 46 of the tooth can be wiped clean from the surround surfaces without displacing the restoration. Once the excess bonding agent 42 is wiped clean, the remaining bonding agent 42 can be cured by the light curing unit to fully bond the restoration 20 to the tooth 40. If desirable, the light transmissive member 12 can be removed from the dental restoration 20 subsequent the step spot curing the bonding agent 42, and the adapter 24 can be removed from the light curing unit prior to curing the remaining bonding agent.

This technique can be used to bond several restorations 20 during a single procedure. In this utilization, several dental restorations 20 can be positioned and spot cured on corresponding teeth 40. Once each dental restoration 20 is spot cured and partially bonded to its respective tooth, the excess bonding agent 42 for each restoration can be wiped cleaned simultaneously. Once the excess bonding agent 42 is removed, the remaining bonding agent of each dental restoration 20 can be cured to fully bond the restoration to its respective tooth.

Thus the technique and dental combination 10 illustrated and described increases the efficiency of the bonding procedure by minimizing the amount of time required to position a dental restoration and remove excess bonding agent prior to fully bonding the dental restoration to a tooth, and improves accurate placement a restoration.

A number of embodiments of the present invention have been described. Nevertheless, it will be understood that various modifications may be made without departing from the spirit and scope of the invention. Accordingly, other embodiments are within the scope of the following claims.

I claim:

1. A method of attaching a dental restoration to a dental surface, the method comprising the steps of:
applying a dental bonding agent to an exterior bonding surface of a dental restoration that will facilitate the adhesion of the dental restoration to a dental surface;
positioning the dental restoration on the dental surface; and
spot hardening the dental bonding agent to partially adhere the dental restoration to the dental surface;
removing excess dental bonding agent; and
hardening the remaining dental bonding agent to fully adhere the dental restoration to the dental surface.

2. The method according to claim 1, wherein during the step of spot hardening the dental bonding agent, the spot hardening is performed at about a central location on the dental restoration.

3. The method according to claim 1, wherein the dental boding agent is a light curable dental bonding agent.

4. The method according to claim 1, wherein during the step of removing excess dental bonding agent, the bonding agent displaced beyond the peripheral edge of the dental restoration during positioning of the dental restoration on the dental surface is the excess dental bonding agent that is removed.

5. A method of attaching a dental restoration to a dental surface, the method comprising the steps of:
attaching a light transmissive member to an outward facing surface of the dental restoration;
applying a light curable dental bonding agent to a bonding surface of the dental restoration that will facilitate the adhesion of the dental restoration to a dental surface;
positioning the dental restoration on the dental surface;
transmitting a source of curing light through the light transmissive member to spot cure the dental bonding agent to partially adhere the dental restoration to the dental surface;
removing excess bonding agent; and
curing the remaining dental bonding agent to fully adhere the dental restoration to the dental surface.

6. The method according to claim 5, wherein the light transmissive member is attached to the outward facing surface about a central point thereon.

7. The method according to claim 5, wherein the light transmissive member is an optical fiber.

8. The method according to claim 7, wherein the optical fiber is of a diameter of about 2.5 to about 3.5 millimeters.

9. The method according to claim 8, wherein the optical fiber is of a length of about 25 to about 35 millimeters.

10. The method according to claim 5, wherein during the step of removing excess dental bonding agent, the bonding agent displaced beyond the outer margin of the dental restoration during positioning of the dental restoration on the dental surface is the excess dental bonding agent that is removed.

11. The method according to claim 5, further comprising the step of:
removing the light transmissive member prior to curing the remaining dental bonding agent.

12. The method according to claim 5, further comprising the step of:
attaching an adapter to an end of the light transmissive member opposite the end attached to the dental restoration, the adapter for facilitating the transmission of curing light from a light curing apparatus through the light transmissive member.

13. The method according to claim 12, wherein the adapter includes a longitudinal through passage through which light from the light curing apparatus if free to pass and wherein the adapter is opaque.

14. The method according to claim 5, further comprising the step of:
applying a dental adhesive to the outward facing surface of the dental restoration for facilitating the attachment of the light transmissive member to the dental restoration.

15. The method according to claim 14, wherein the dental adhesive is a dental wax.

16. The method according to claim 15, wherein the dental wax is light transmissive.

17. A dental combination for attaching a dental restoration, the dental combination comprising:
a dental restoration having a surface to be bonded to a tooth and an outward facing surface which becomes a surface of the tooth;
an optical fiber; and
a dental adhesive connecting a proximal end of said optical fiber to said outward facing surface of said dental restoration with said optical fiber extending generally perpendicular from said outward facing surface and terminating at a distal end.

18. The dental combination of claim 17, wherein said dental adhesive is a dental wax.

19. The dental combination of claim 17, further comprising:
an adapter having opposed ends, a first end of said opposed ends being removably attachable to said distal end of said optical fiber and the second end of said opposed ends being removably attachable to a light transmitting end of a light curing apparatus.

20. The dental combination of claim 19, wherein said adapter conical shaped and further wherein the narrow end is removably attachable to said distal end of said optical fiber.
